(19) United States
(12) Patent Application Publication
(10) Pub. No.: US 2025/0209582 A1
(43) Pub. Date: Jun. 26, 2025

(54) IMAGE PROCESSING APPARATUS, IMAGE CAPTURING APPARATUS, IMAGE PROCESSING METHOD, AND STORAGE MEDIUM

(71) Applicant: CANON KABUSHIKI KAISHA, Tokyo (JP)

(72) Inventor: NAOTO KIMURA, Kanagawa (JP)

(21) Appl. No.: 18/983,845

(22) Filed: Dec. 17, 2024

(30) Foreign Application Priority Data
Dec. 25, 2023 (JP) 2023-218434

(51) Int. Cl. G06T 5/92

(52) U.S. Cl. CPC G06T 5/92

(57) ABSTRACT

An image processing apparatus generates a first and evaluation images based on an image, generates, based on the first evaluation image, a first gain map for first tone mapping processing, applies the first tone mapping processing that is based on the first gain map to the second evaluation image, generates, based on the second evaluation image to which the first tone mapping processing has already been applied, a second gain map for second tone mapping processing different from the first tone mapping processing, applies the first tone mapping processing that is based on the first gain map to the image, and applies the second tone mapping processing that is based on the second gain map to the image to which the first tone mapping processing has already been applied.

### BACKGROUND

### Field of the Disclosure

The present disclosure relates to an image processing apparatus, an image capturing apparatus, an image processing method, and a storage medium.

### Description of the Related Art

A plurality of types of tone mapping processing that can be applied to images are known. The following are known as these plurality of types of tone mapping processing: highlight/shadow correction for correcting dark scenes and excessively bright scenes, clarity correction for providing a sharp image by correcting local contrast, haze correction for removing haze, and the like. In haze correction, the amount of haze in an image is estimated as a transmission map based on a known method called the dark channel prior method, which uses a haze model.

Japanese Patent Laid-Open No. 2020-195127 discloses a technique to control which one of haze correction and tone correction, which uses a tone curve, is to be performed with respect to an image.

A user who has shot an image with a camera or the like may desire to correct the image using a plurality of types of tone mapping processing in combination. In this case, as the amount of calculation in tone mapping processing is generally large, it takes a long time to obtain the image to which the plurality of types of tone mapping processing desired by the user have been applied.

### SUMMARY

The present disclosure has been made in view of the foregoing circumstance, and provides a technique to reduce a time period required to apply a plurality of types of tone mapping processing to an image.

According to a first aspect of the present disclosure, there is provided an image processing apparatus, comprising: at least one memory configured to store instructions; and at least one processor in communication with the at least one memory and configured to execute the instructions to: generate, based on an image, a first evaluation image for first tone mapping processing; generate, based on the image, a second evaluation image for second tone mapping processing, the second tone mapping processing being different from the first tone mapping processing; generate, based on the first evaluation image, a first gain map for the first tone mapping processing; apply the first tone mapping processing that is based on the first gain map to the second evaluation image; generate, based on the second evaluation image to which the first tone mapping processing has already been applied, a second gain map for the second tone mapping processing; apply the first tone mapping processing that is based on the first gain map to the image; and apply the second tone mapping processing that is based on the second gain map to the image to which the first tone mapping processing has already been applied.

According to a second aspect of the present disclosure, there is provided an image capturing apparatus, comprising: the image processing apparatus according to the first aspect; and an image capturing sensor configured to generate the image.

According to a third aspect of the present disclosure, there is provided an image processing method executed by an image processing apparatus, comprising: generating, based on an image, a first evaluation image for first tone mapping processing; generating, based on the image, a second evaluation image for second tone mapping processing, the second tone mapping processing being different from the first tone mapping processing; generating, based on the first evaluation image, a first gain map for the first tone mapping processing; applying the first tone mapping processing that is based on the first gain map to the second evaluation image; generating, based on the second evaluation image to which the first tone mapping processing has already been applied, a second gain map for the second tone mapping processing; applying the first tone mapping processing that is based on the first gain map to the image; and applying the second tone mapping processing that is based on the second gain map to the image to which the first tone mapping processing has already been applied.

According to a fourth aspect of the present disclosure, there is provided a non-transitory computer-readable storage medium which stores a program for causing a computer to execute an image processing method comprising: generating, based on an image, a first evaluation image for first tone mapping processing; generating, based on the image, a second evaluation image for second tone mapping processing, the second tone mapping processing being different from the first tone mapping processing; generating, based on the first evaluation image, a first gain map for the first tone mapping processing; applying the first tone mapping processing that is based on the first gain map to the second evaluation image; generating, based on the second evaluation image to which the first tone mapping processing has already been applied, a second gain map for the second tone mapping processing; applying the first tone mapping processing that is based on the first gain map to the image; and applying the second tone mapping processing that is based on the second gain map to the image to which the first tone mapping processing has already been applied.

Further features of the present disclosure will become apparent from the following description of exemplary embodiments with reference to the attached drawings.

### BRIEF DESCRIPTION OF THE DRAWINGS

FIG. 1 is a block diagram showing a configuration of an image capturing apparatus 100 that includes an image processing apparatus.

FIG. 2 is a block diagram showing a configuration of an image processing unit 102.

FIG. 3 is a flowchart showing the operations of the image processing unit 102 according to one or more aspects of the present disclosure.

FIG. 4 is a block diagram showing a configuration of each of a first evaluation image generation unit 202 and a second evaluation image generation unit 203 according to one or more aspects of the present disclosure.

FIG. 5 is a flowchart showing the details of processing in each of steps S302 and S303.

FIG. 6 is a conceptual diagram of layer images.

FIGS. 7A to 7C are graphs depicting a conversion table for converting pixel values of an evaluation image into gains.

FIG. 8 is a flowchart showing the operations of the image processing unit 102 according to one or more aspects of the present disclosure.

FIG. 9 is a block diagram showing a configuration of each of the first evaluation image generation unit 202 and the second evaluation image generation unit 203 according to one or more aspects of the present disclosure.

FIG. 10 is a flowchart showing the details of processing in each of steps S802 and S803.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate.

Furthermore, in the attached drawings, the same reference numerals are given to the same or similar configurations, and redundant description thereof is omitted.

### First Embodiment

### Configuration of Image Capturing Apparatus 100

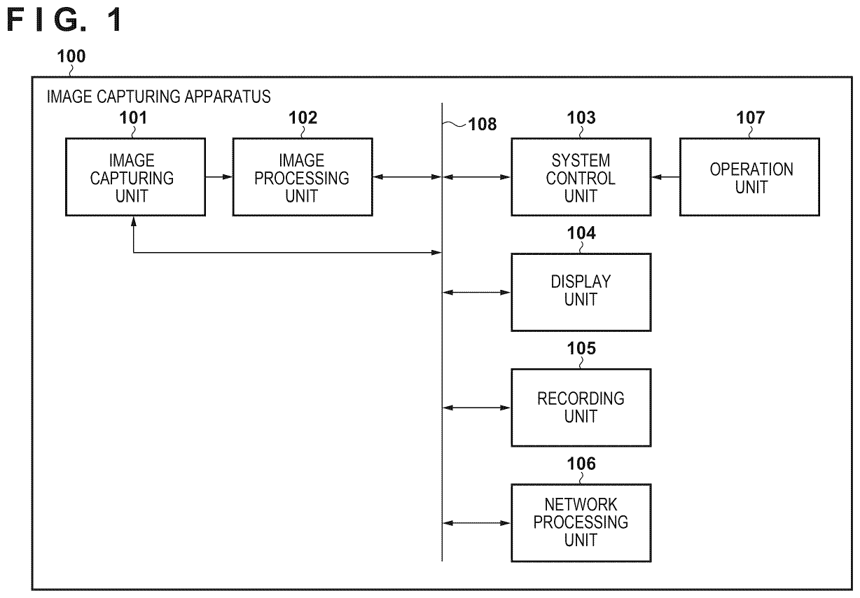

FIG. 1 is a block diagram showing a configuration of an image capturing apparatus 100 that includes an image processing apparatus. In the present embodiment, it is assumed that the image capturing apparatus 100 shoots a monochrome image, and executes two types of tone mapping processing with respect to the shot monochrome image. The image capturing apparatus 100 generates two types of evaluation images for the two types of tone mapping processing in parallel, and then serially reflects two types of effects corresponding to the two types of tone mapping processing in the monochrome image.

Specific contents of the two types of tone mapping processing are not limited in particular. In the following description, it is assumed that one of the two types of tone mapping processing (first tone mapping processing) is one of highlight/shadow correction which is one type of brightness correction, clarity correction which is one type of contrast correction, and haze correction. Also, it is assumed that the other one of the two types of tone mapping processing (second tone mapping processing) is one of the highlight/shadow correction, clarity correction, and haze correction, and is different from the first tone mapping processing. Furthermore, the image capturing apparatus 100 may execute three or more types of tone mapping processing, and the configurations of the present embodiment described below are also applicable to a case where the image capturing apparatus 100 executes three or more types of tone mapping processing.

An image capturing unit 101 includes lenses, a monochrome image sensor, an A/D conversion processing unit, and a development processing unit. The image capturing unit 101 generates an image by shooting a subject image based on a control signal output from a system control unit 103 in accordance with a user instruction via an operation unit 107.

An image processing unit 102 executes the two types of tone mapping processing with respect to an image input from the image capturing unit 101, a recording unit 105, or a network processing unit 106. The details of the image processing unit 102 will be described later.

The system control unit 103 includes a ROM in which a control program is stored, and a RAM used as a working memory, and performs integrated control on the operations of the entire image capturing apparatus 100 in accordance with the control program. Also, the system control unit 103 performs, for example, control for driving the image capturing unit 101 based on a control signal input from the network processing unit 106 and the operation unit 107.

A display unit 104 is a display device that includes a liquid crystal display or an organic electro luminescence (EL) display, and displays images output from the image processing unit 102.

The recording unit 105 has a function of recording data of images and the like. For instance, the recording unit 105 may include an information recording medium that uses, for example, a package housing a memory card equipped with a semiconductor memory or a rotary recording object, such as a magneto-optical disc. This information recording medium may be configured to be attachable to and removable from the image capturing apparatus 100.

The network processing unit 106 executes processing for communicating with an external device. For example, the network processing unit 106 may be configured to obtain images from an external input device via a network. Also, the network processing unit 106 may be configured to transmit images output from the image processing unit 102 to an external display device or image processing apparatus (e.g., a personal computer (PC)) via a network.

The operation unit 107 is configured to include such operation members as buttons and a touch panel, and to accept an input operation performed by a user. The operation unit 107 outputs a control signal corresponding to the user's input operation to the system control unit 103. The user can issue a user instruction to the system control unit 103 via the input operation performed on the operation unit 107.

A bus 108 is used to exchange data of images and the like among the image capturing unit 101, image processing unit 102, system control unit 103, display unit 104, recording unit 105, and network processing unit 106.

### Configuration of Image Processing Unit 102

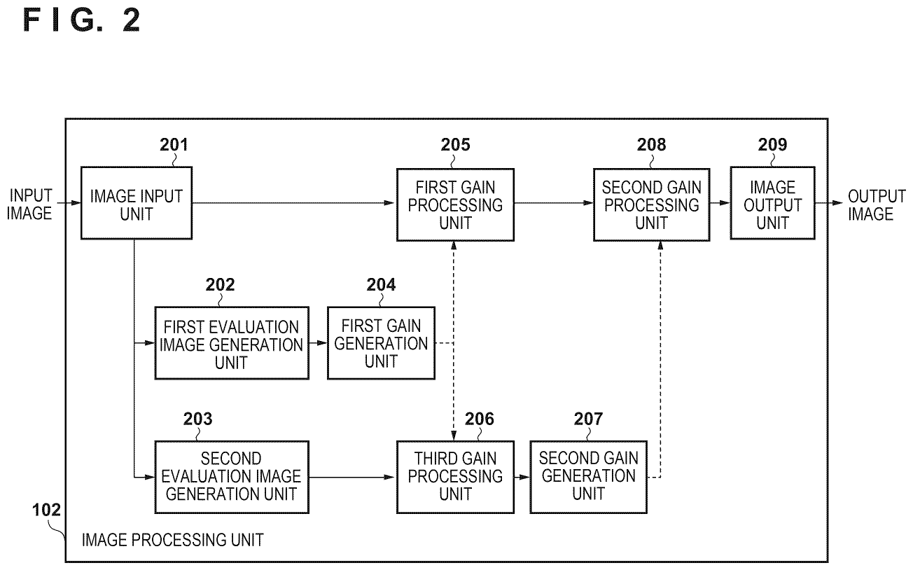

Next, a configuration of the image processing unit 102 will be described with reference to FIG. 2. As shown in FIG. 2, the image processing unit 102 includes an image input unit 201, a first evaluation image generation unit 202, a second evaluation image generation unit 203, a first gain generation unit 204, a first gain processing unit 205, and a third gain processing unit 206. Also, the image processing unit 102 includes a second gain generation unit 207, a second gain processing unit 208, and an image output unit 209. An image input to the image processing unit 102 via the image input unit 201 is a target image for the two types of tone mapping processing (a monochrome image in the present embodiment). An image output from the image processing unit 102 via the image output unit 209 is the monochrome image to which the two types of tone mapping processing have been applied. The operations of each unit of the image processing unit 102 will be described later.

### Operations of Image Processing Unit 102

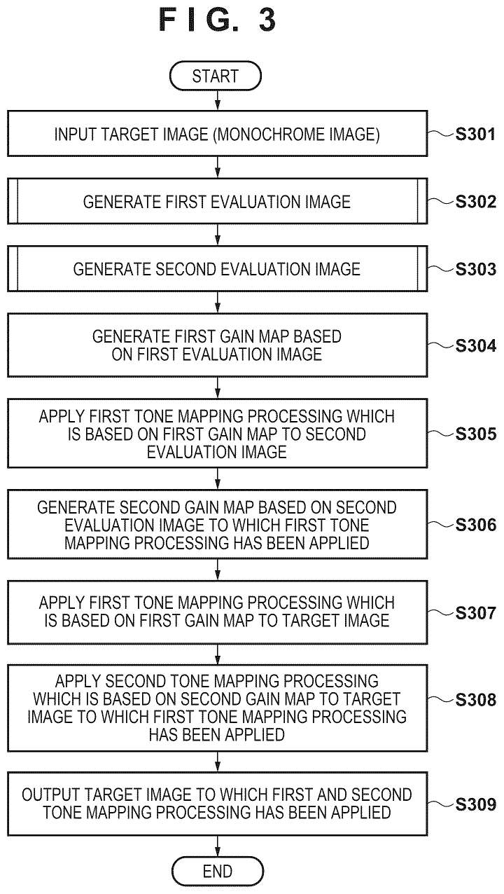

FIG. 3 is a flowchart showing the operations of the image processing unit 102 according to the first embodiment. In step S301, the image input unit 201 accepts an input of a target image for tone mapping processing.

In step S302, the first evaluation image generation unit 202 generates a first evaluation image for the first tone mapping processing based on the image input in step S301. The details of processing of step S302 will be described later.

In step S303, the second evaluation image generation unit 203 generates a second evaluation image for the second tone mapping processing based on the image input in step S301. The details of processing of step S303 will be described later together with the details of processing of step S302.

In step S304, the first gain generation unit 204 generates a first gain map for the first tone mapping processing based on the first evaluation image generated in step S302. A gain map is an image that has values of gains to be applied to the respective pixels in a target image for tone mapping processing as pixel values. The details of processing of step S304 will be described later.

In step S305, the third gain processing unit 206 applies gain processing (the first tone mapping processing) based on the first gain map generated in step S304 to the second evaluation image generated in step S303. The details of processing of step S305 will be described later.

In step S306, the second gain generation unit 207 generates a second gain map for the second tone mapping processing based on the second evaluation image to which the first tone mapping processing has already been applied in step S305. The details of processing of step S306 will be described later together with the details of processing of step S304.

In step S307, the first gain processing unit 205 applies gain processing (the first tone mapping processing) based on the first gain map generated in step S304 to the image input in step S301. The details of processing of step S307 will be described later.

In step S308, the second gain processing unit 208 applies gain processing (the second tone mapping processing) based on the second gain map generated in step S306 to the image to which the first tone mapping processing has already been applied in step S307. The details of processing of step S308 will be described later.

In step S309, the image output unit 209 outputs the image to which the second tone mapping processing has already been applied in step S308 as an output image.

Through the foregoing processing, an image to which two types of tone mapping processing have been applied is generated.

### Details of Processing of Steps S302 and S303

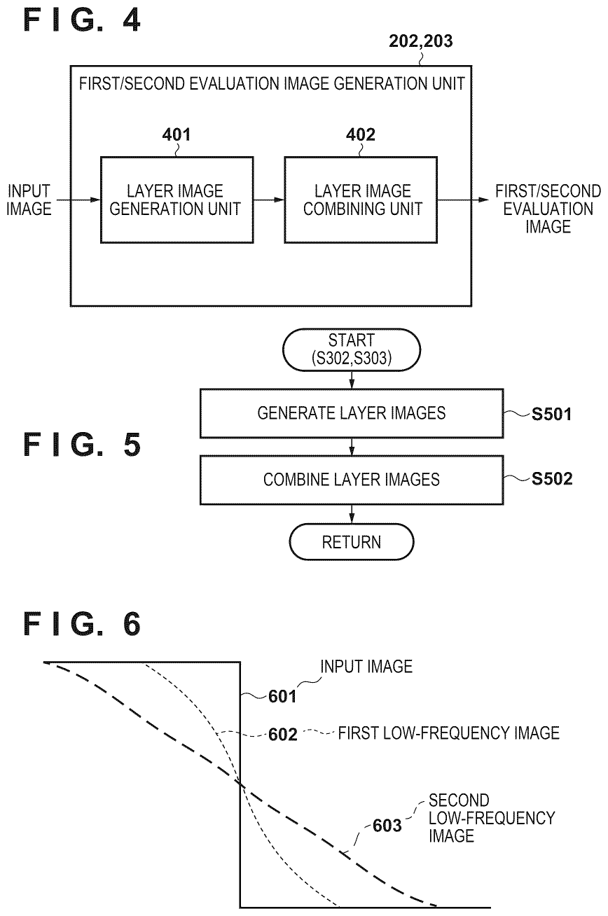

Next, the details of processing of steps S302 and S303 will be described with reference to FIG. 4 to FIG. 6. FIG. 4 is a block diagram showing a configuration of each of the first evaluation image generation unit 202 and the second evaluation image generation unit 203 according to the first embodiment. Each of the first evaluation image generation unit 202 and the second evaluation image generation unit 203 can be depicted as the same block diagram.

Each of the first evaluation image generation unit 202 and the second evaluation image generation unit 203 includes a layer image generation unit 401 and a layer image combining unit 402. An image input to the layer image generation unit 401 is a monochrome image input to the image input unit 201. An image output from the layer image combining unit 402 is an evaluation image that is necessary to generate a gain map for tone mapping processing.

FIG. 5 is a flowchart showing the details of processing in each of steps S302 and S303. Although the following mainly describes processing of step S302 executed by the first evaluation image generation unit 202, processing of step S303 executed by the second evaluation image generation unit 203 is also similar to the processing described below.

In step S501, the layer image generation unit 401 executes processing for generating layer images. The layer images refer to a plurality of images with different frequencies. FIG. 6 is a conceptual diagram of the layer images. In FIG. 6, a horizontal axis indicates pixel positions, and a vertical axis indicates signal values (pixel values). In the example of FIG. 6, the layer images include three types of images: an input image 601, a first low-frequency image 602, and a second low-frequency image 603. The input image 601 is a monochrome image input from the image input unit 201. The first low-frequency image 602 is an image obtained by applying a first low-pass filter to the input image 601. The second low-frequency image 603 is an image obtained by applying a second low-pass filter, which is different in characteristics from the first low-pass filter, to the input image 601. Note that images different from the example of FIG. 6 may be used as the layer images. For example, a plurality of images with different resolutions, which are generated through reduction processing or the like, may be used as the layer images.

In step S502, the layer image combining unit 402 executes processing for generating one evaluation image by combining the layer images generated in step S501. This processing varies depending on the type of tone mapping processing.

In a case where the first tone mapping processing is highlight/shadow correction, the layer image combining unit 402 of the first evaluation image generation unit 202 generates the first evaluation image by way of weighted addition of pixel values in each of the layer images in accordance with the following formula (1). Note that (x, y) indicates pixel coordinates (pixel position), and pix (x, y) indicates a pixel value (monochrome signal) in the input image 601. Also, lpf1 (x, y) indicates a pixel value in the first low-frequency image 602, lpf2 (x, y) indicates a pixel value in the second low-frequency image 603, and eva (x, y) indicates a pixel value in the evaluation image. Furthermore, α, β, and γ indicate weight coefficients for the weighted addition.

$$[ Math . 1 ]$$

$$eva ( x , y ) = \frac{( α \times p ix ( x , y ) + β \times lpf 1 ( x , y ) + γ \times lpf 2 ( x , y ) )}{α + β + γ} \qquad ( 1 )$$

Also, in a case where the first tone mapping processing is clarity correction, the layer image combining unit 402 of the first evaluation image generation unit 202 generates the first evaluation image by extracting alternating-current components (AC components) from the layer images in accordance with the following formula (2).

$$[ Math . 2 ]$$

$$eva ( x , y ) = pix ( x , y ) - \frac{( α \times p i x ( x , y ) + β \times lpf 1 ( x , y ) + γ \times lpf 2 ( x , y ) )}{α + β + γ} \qquad ( 2 )$$

Furthermore, in a case where the first tone mapping processing is haze correction, the layer image combining unit 402 of the first evaluation image generation unit 202 generates the first evaluation image by obtaining the minimum value of each layer in accordance with the following formula (3) based on a known method called the dark channel prior method.

$$[ Math . 3 ]$$

$$eva ( x , y ) = min ( pix ( x , y ) , lpf 1 ( x , y ) , lpf 2 ( x , y ) \qquad ( 3 )$$

Similarly, the layer image combining unit 402 of the second evaluation image generation unit 203 generates the second evaluation image in accordance with one of the formulae (1) to (3) in accordance with the type of the second tone mapping processing. In this case, eva (x, y) in the formulae (1) to (3) indicates the second evaluation image.

### Details of Processing of Steps S304 and S306

Next, the details of processing of steps S304 and S306 will be described. The details of processing of steps S304 and S306 vary depending on the type of tone mapping processing. Although the following mainly describes processing of step S304 executed by the first gain generation unit 204, processing of step S306 executed by the second gain generation unit 207 is also similar to the processing described below. Regarding processing of step S306, it is sufficient to read “first tone mapping processing”, “first gain generation unit 204”, and “first evaluation image” in the following description as “second tone mapping processing”, “second gain generation unit 207”, and “second evaluation image”, respectively.

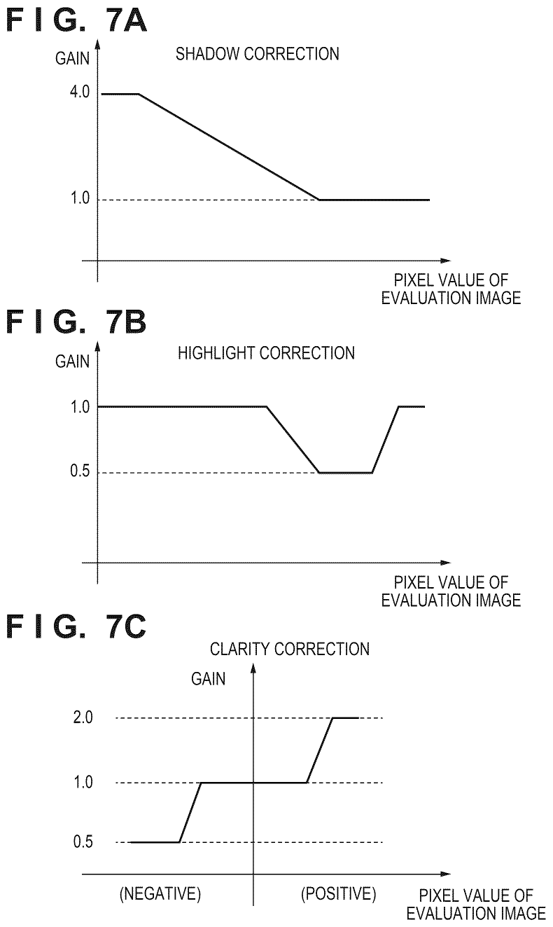

In a case where the first tone mapping processing is highlight/shadow correction, the first gain generation unit 204 converts pixel values of the first evaluation image into gains in accordance with FIG. 7A and FIG. 7B. FIG. 7A is a graph representing a conversion table for converting pixel values of the evaluation image into gains in relation to shadow correction of the highlight/shadow correction. FIG. 7B is a graph representing a conversion table for converting pixel values of the evaluation image into gains in relation to highlight correction of the highlight/shadow correction. In FIG. 7A and FIG. 7B, a horizontal axis indicates pixel values of the evaluation image, and a vertical axis indicates gain values. In the example of FIG. 7A, the conversion table has characteristics whereby a gain larger than one fold is applied to a dark pixel (a pixel with a small pixel value). In the example of FIG. 7B, the conversion table has characteristics whereby a gain smaller than one fold is applied to a relatively bright pixel (a pixel with a relatively large pixel value). For example, the first gain generation unit 204 determines a region to which shadow correction is to be applied and a region to which highlight correction is to be applied out of the first evaluation image. Then, the first gain generation unit 204 converts each pixel value of the region to which shadow correction is to be applied into a gain in accordance with FIG. 7A, and converts each pixel value of the region to which highlight correction is to be applied into a gain in accordance with FIG. 7B, thereby generating a first gain map.

In a case where the first tone mapping processing is clarity correction, the first gain generation unit 204 converts pixel values of the first evaluation image into gains in accordance with FIG. 7C. FIG. 7C is a graph representing a conversion table for converting pixel values of the evaluation image into gains in relation to clarity correction. In FIG. 7C, a horizontal axis indicates pixel values of the evaluation image, and a vertical axis indicates gain values. As has been described above with reference to formula (2), in a case where the first tone mapping processing is clarity correction, the pixel values of the first evaluation image are AC components extracted from layer images. Therefore, in the example of FIG. 7C, the conversion table has characteristics whereby a one-fold gain is applied to a portion with a small amplitude, and a gain that emphasizes amplitudes of the AC components is applied to a portion with a large amplitude.

In a case where the first tone mapping processing is haze correction, the first gain generation unit 204 generates the first gain map by obtaining a transmission map t (x, y) in accordance with the following formula (4), and then obtaining gains in accordance with the following formula (5).

$$[ Math . 4 ]$$

$$t ( x , y ) = \frac{1}{\{ ( \frac{A}{A - eva ( x , y )} ) - 1 \} \times K + 1} \qquad ( 4 )$$

$$[ Math . 5 ]$$

$$gain ( x , y ) = \frac{1}{t ( x , y )} \qquad ( 5 )$$

In formula (4), eva (x, y) indicates a pixel value at coordinates (x, y) in the evaluation image that has been obtained in accordance with the aforementioned formula (3). A is a signal value indicating an atmospheric image in a haze model; any value can be used thereas, such as a luminance value of the sky, a luminance value of a light source like the sun, a light, or the like, and the maximum value that an image signal can take (e.g., 4095 in the case of a 12-bit image signal). K is an arbitrary parameter, and the intensity of the transmission map for haze correction can be adjusted by adjusting the value of K.

Note that in the foregoing description, it is assumed that the first evaluation image generation unit 202 and the first gain generation unit 204 are different blocks. However, in view of the characteristics whereby the first tone mapping processing for the target image is executed prior to the second tone mapping processing, processing of the first gain generation unit 204 may be executed inside the first evaluation image generation unit 202.

### Details of Processing of Step S305

Next, the details of processing of step S305 will be described. The details of processing of step S305 vary depending on the type of the first tone mapping processing.

In a case where the first tone mapping processing is highlight/shadow correction or clarity correction, the third gain processing unit 206 applies the first gain map to the second evaluation image in accordance with the following formula (6). In formula (6), eva2 (x, y) indicates the second evaluation image generated in step S303, gain1 (x, y) indicates the first gain map generated in step S304, and out_eva2 (x, y) indicates the second evaluation image to which the first tone mapping processing based on the first gain map has already been applied.

$$[ Math . 6 ]$$

$$out\_eva 2 ( x , y ) = gain 1 ( x , y ) \times eva 2 ( x , y ) \qquad ( 6 )$$

In a case where the first tone mapping processing is haze correction, the third gain processing unit 206 applies the first gain map to the second evaluation image in accordance with the following formula (7), which is based on the haze model. In formula (7), eva2 (x, y), gain1 (x, y), and out_eva2 (x, y) indicate the same things as in formula (6), and “A” indicates the same thing as in formula (4).

$$[ Math . 7 ]$$

$$out\_eva2 ( x , y ) = gain 1 ( x , y ) \times ( eva 2 ( x , y ) - A ) + A \qquad ( 7 )$$

### Details of Processing of Step S307

Next, the details of processing of step S307 will be described. Although the details of processing of step S307 are similar to step S305, the following formula (8) or formula (9) is used in place of formula (6) or formula (7). In formula (8) and formula (9), gain1 (x, y) indicates the first gain map generated in step S304, pix (x, y) indicates the image input in step S301 (the target image for the tone mapping processing), and out1_pix (x, y) indicates the target image to which the first tone mapping processing based on the first gain map has already been applied. The first gain processing unit 205 executes gain processing (the first tone mapping processing) for applying the first gain map to the target image in accordance with formula (8) (in a case where the first tone mapping processing is highlight/shadow correction or clarity correction), or formula (9) (the first tone mapping processing is haze correction).

$$[ Math . 8 ]$$

$$out1\_pix ( x , y ) = gain 1 ( x , y ) \times pix ( x , y ) \qquad ( 8 )$$

$$[ Math . 9 ]$$

$$out1\_pix ( x , y ) = gain 1 ( x , y ) \times ( p i x ( x , y ) - A ) + A \qquad ( 9 )$$

### Details of Processing of Step S308

Next, the details of processing of step S308 will be described. Although the details of processing of step S308 are similar to step S307, the following formula (10) or formula (11) is used in place of formula (8) or formula (9). In formula (10) and formula (11), gain2 (x, y) indicates the second gain map generated in step S306, out1_pix (x, y) indicates the target image to which the first tone mapping processing has already been applied in step S307, and out2_pix (x, y) indicates the target image to which the first tone mapping processing and the second tone mapping processing have already been applied. The second gain processing unit 208 executes gain processing (the second tone mapping processing) for applying the second gain map to the target image to which the first tone mapping processing has already been applied in accordance with formula (10) (in a case where the second tone mapping processing is highlight/shadow correction or clarity correction) or formula (11) (in a case where the second tone mapping processing is haze correction).

$$[ Math . 10 ]$$

$$out2\_pix ( x , y ) = gain 2 ( x , y ) \times out1\_pix ( x , y ) \qquad ( 10 )$$

$$[ Math . 11 ]$$

$$out2\_pix ( x , y ) = gain 2 ( x , y ) \times ( out1\_pix ( x , y ) - A ) + A \qquad ( 11 )$$

### Summary of First Embodiment

As described above, according to the first embodiment, the image processing unit 102 generates the first evaluation image for the first tone mapping processing based on the input target image. Also, the image processing unit 102 generates the second evaluation image for the second tone mapping processing, which is different from the first tone mapping processing, based on the target image. The image processing unit 102 generates the first gain map for the first tone mapping processing based on the first evaluation image, and applies the first tone mapping processing based on the first gain map to the second evaluation image. Then, the image processing unit 102 generates the second gain map for the second tone mapping processing based on the second evaluation image to which the first tone mapping processing has already been applied. Subsequently, the image processing unit 102 applies the first tone mapping processing based on the first gain map to the target image, and applies the second tone mapping processing based on the second gain map to the target image to which the first tone mapping processing has already been applied.

In this way, in the first embodiment, the first evaluation image and the second evaluation image are generated based on the same target image. Therefore, the image processing unit 102 can execute processing for generating the second evaluation image for the second tone mapping processing without waiting for completion of the first tone mapping processing for the target image. Also, when the first gain map has already been generated, the image processing unit 102 can execute processing for applying the first tone mapping processing based on the first gain map to the second evaluation image, and processing for generating the second gain map, without waiting for completion of the first tone mapping processing for the target image. In this way, the image processing unit 102 can execute at least parts of processing necessary for the first tone mapping processing and processing necessary for the second tone mapping processing in parallel. Therefore, according to the first embodiment, a time period required to apply a plurality of types of tone mapping processing to an image can be reduced.

### Second Embodiment

In the first embodiment, the target image for the two types of tone mapping processing is a monochrome image. In contrast, a second embodiment will be described in relation to a case where the target image for the two types of tone mapping processing is a color image (RGB image) including red (R), green (G), and blue (B) components. In the second embodiment, the basic configuration of the image capturing apparatus 100 is similar to the first embodiment, except that a part thereof is changed due to the target image being a color image. The following mainly describes the differences from the first embodiment.

In the second embodiment, the image sensor included in the image capturing unit 101 of FIG. 1 is a color image sensor (RGB sensor). Therefore, an image input to the image processing unit 102 via the image input unit 201 of FIG. 2 (a target image for the two types of tone mapping processing) is an RGB image, and an image output from the image processing unit 102 via the image output unit 209 is also an RGB image.

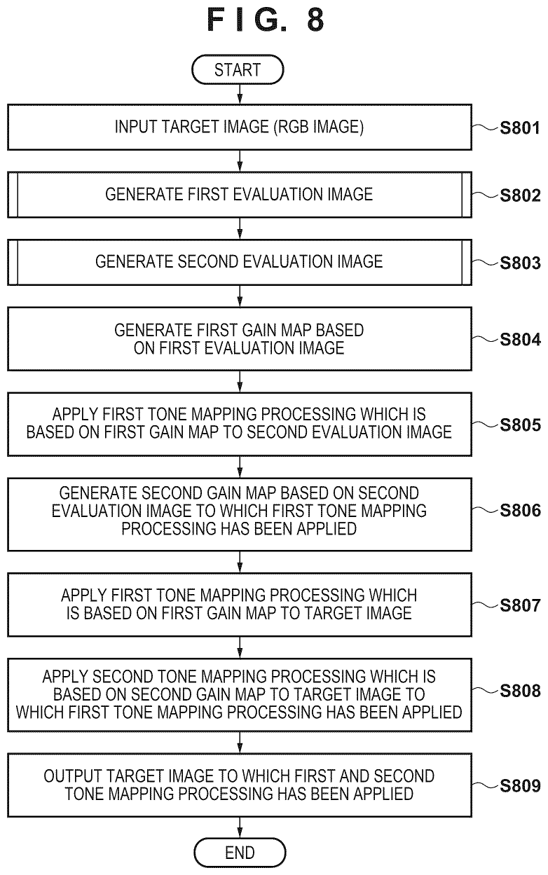

Next, the operations of the image processing unit 102 will be described with reference to FIG. 8. Processing of step S801 is similar to step S301 of FIG. 3, except that the target image is the RGB image.

In step S802, the first evaluation image generation unit 202 generates a first evaluation image for the first tone mapping processing based on the image input in step S801. In step S803, the second evaluation image generation unit 203 generates a second evaluation image for the second tone mapping processing based on the image input in step S801.

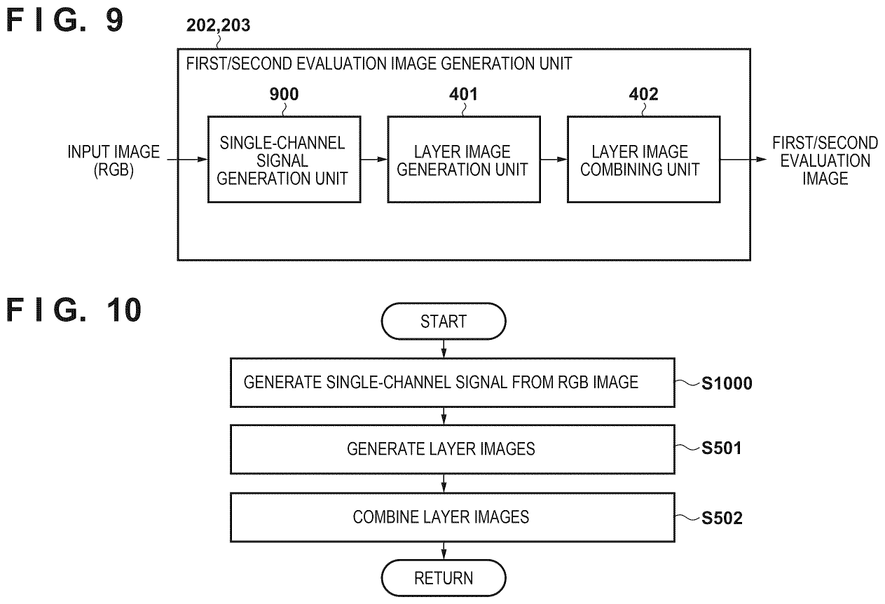

The details of processing of steps S802 and S803 will now be described with reference to FIG. 9 and FIG. 10. FIG. 9 is a block diagram showing a configuration of each of the first evaluation image generation unit 202 and the second evaluation image generation unit 203 according to the second embodiment. Each of the first evaluation image generation unit 202 and the second evaluation image generation unit 203 can be depicted as the same block diagram.

Each of the first evaluation image generation unit 202 and the second evaluation image generation unit 203 includes a single-channel signal generation unit 900, a layer image generation unit 401, and a layer image combining unit 402. An image input to the single-channel signal generation unit 900 is the RGB image input to the image input unit 201. An image output from the layer image combining unit 402 is an evaluation image that is necessary to generate a gain map for tone mapping processing.

FIG. 10 is a flowchart showing the details of processing in each of steps S802 and S803. Although the following mainly describes processing of step S802 executed by the first evaluation image generation unit 202, processing of step S803 executed by the second evaluation image generation unit 203 is also similar to the processing described below.

In step S1000, the single-channel signal generation unit 900 executes processing for generating a single-channel signal that is appropriate for generation of a first evaluation image for the first tone mapping processing from tri-channel signals (RGB signals) included in the input RGB image.

In a case where the first tone mapping processing is highlight/shadow correction or clarity correction, the single-channel signal generation unit 900 generates a single-channel luminance signal by way of weighted addition of RGB signals in accordance with the following formula (12). In formula (12), R (x, y), G (x, y), and B (x, y) indicate RGB signals at coordinates (x, y), and pix (x, y) indicates a luminance signal. k_{R}, k_{G}, and k_{B} are weight coefficients for the weighted addition, and any values can be used thereas.

$$[ Math . 12 ]$$

$$pix ( x , y ) = \frac{{k}_{R} \times R ( x , y ) + {k}_{G} \times G ( x , y ) + {k}_{B} \times B ( x , y )}{{k}_{R} + {k}_{G} + {k}_{B}} \qquad ( 12 )$$

In a case where the first tone mapping processing is haze correction, the single-channel signal generation unit 900 generates a single-channel signal by selecting the smallest signal among the RGB signals in accordance with the following formula (13). In formula (13), R (x, y), G (x, y), and B (x, y) indicate RGB signals at coordinates (x, y), and pix (x, y) indicates a single-channel signal that has been selected as the smallest signal from among the RGB signals.

$$[ Math . 13 ]$$

$$pix ( x , y ) = min ( R ( x , y ) , G ( x , y ) , B ( x , y ) ) \qquad ( 13 )$$

As pix (x, y) generated from formula (12) or formula (13) is a single-channel signal similarly to the monochrome image in the first embodiment, it can be treated as pix (x, y) in formulae (1) to (3) described in the first embodiment. Therefore, in steps S501 and S502 of the second embodiment (FIG. 10), the layer image generation unit 401 and the layer image combining unit 402 generate the first evaluation image in accordance with one of formulae (1) to (3) similarly to steps S501 and S502 of the first embodiment (FIG. 5).

Referring back to FIG. 8, in step S804, the first gain generation unit 204 generates a first gain map for the first tone mapping processing based on the first evaluation image generated in step S802. In a case where the first tone mapping processing is highlight/shadow correction or clarity correction, the first gain generation unit 204 can generate the first gain map in accordance with the conversion table of FIG. 7 similarly to step S304 of FIG. 3.

On the other hand, in a case where the first tone mapping processing is haze correction, the first gain generation unit 204 generates a transmission map and a gain map for each of the RGB signals in accordance with the following formula (14) and formula (15) in place of formula (4) and formula (5), which have been described in relation to step S304 of FIG. 3. In formula (14) and formula (15), t_{R} (x, y), t_{G} (x, y), and t_{B} (x, y) respectively indicate the transmission map for the R signal, the transmission map for the G signal, and the transmission map for the B signal. Also, gain_{R} (x, y), gain_{G} (x, y), and gains (x, y) respectively indicate the gain map for the R signal, the gain map for the G signal, and the gain map for the B signal. eva (x, y) indicates the first evaluation image. A_{R}, A_{G}, and A_{B} are signal values which indicate an atmospheric image in a haze model and which correspond to R, G, and B, respectively; any values can be used thereas, such as signal values of the sky that respectively correspond to R, G, and B, signal values of a light source like the sun, a light, or the like that respectively correspond to R, G, and B, and the maximum value that an image signal can take (e.g., 4095 in the case of 12-bit image signals). Furthermore, K is an arbitrary parameter common to R, G, and B, and the intensity of the transmission maps for haze correction can be adjusted by adjusting the value of K.

$$[ Math . 14 ]$$

$${t}_{R} ( x , y ) = \frac{1}{\{ ( \frac{{A}_{R}}{{A}_{R} - eva ( x , y )} ) - 1 \} \times K + 1} {t}_{G} ( x , y ) = \frac{1}{\{ ( \frac{{A}_{G}}{{A}_{G} - eva ( x , y )} ) - 1 \} \times K + 1} {t}_{B} ( x , y ) = \frac{1}{\{ ( \frac{{A}_{B}}{{A}_{B} - eva ( x , y )} ) - 1 \} \times K + 1} \qquad ( 14 )$$

$$[ Math . 15 ]$$

$${gain}_{R} ( x , y ) = \frac{1}{{t}_{R} ( x , y )} {gain}_{G} ( x , y ) = \frac{1}{{t}_{G} ( x , y )} {gain}_{B} ( x , y ) = \frac{1}{{t}_{B} ( x , y )} \qquad ( 15 )$$

Referring back to FIG. 8, in step S805, the third gain processing unit 206 executes gain processing (the first tone mapping processing) for applying the first gain map generated in step S804 to the second evaluation image generated in step S803. This processing is substantially the same as processing of step S305 of FIG. 3, and is executed in accordance with formula (6) or formula (7) depending on the type of the first tone mapping processing. Note that in a case where the first tone mapping processing is haze correction, the first gain maps for the respective RGB signals are generated in step S804. Also, a signal value indicating the atmospheric image in the haze model is determined for each of R, G, and B. In view of this, the third gain processing unit 206 uses, for example, the values for the G signal (gainG (x, y) and A_{G}) as gain1 (x, y) and A of formula (7). Alternatively, the third gain processing unit 206 may use values for the R signal or the B signal as gain1 (x, y) and A of formula (7), or may use values obtained by applying weighted averaging to values for the R signal, values for the G signal, and values for the B signal.

In step S806, the second gain generation unit 207 generates a second gain map for the second tone mapping processing based on the second evaluation image to which the first tone mapping processing has already been applied in step S805. In a case where the second tone mapping processing is highlight/shadow correction or clarity correction, the second gain generation unit 207 can generate the second gain map in accordance with the conversion table of FIG. 7 similarly to step S306 of FIG. 3. On the other hand, in a case where the second tone mapping processing is haze correction, the second gain generation unit 207 generates transmission maps and second gain maps in accordance with formula (14) and formula (15) similarly to step S804. In this case, in formula (14), eva (x, y) indicates the second evaluation image.

In step S807, the first gain processing unit 205 applies gain processing (the first tone mapping processing) for applying the first gain map generated in step S804 to the image input in step S801. This processing varies depending on the type of the first tone mapping processing.

In a case where the first tone mapping processing is highlight/shadow correction or clarity correction, the first gain processing unit 205 applies the first gain map for each of R, G, and B in accordance with formula (16). In the following formula (16), R (x, y), G (x, y), and B (x, y) indicate the RGB signals of the target image, and gain1 (x, y) indicates the first gain map. out1_R (x, y), out1_G (x, y), and out1_B (x, y) indicate the RGB signals to which the first tone mapping processing has already been applied.

$$[ Math . 16 ]$$

$$out1\_R ( x , y ) = gain 1 ( x , y ) \times R ( x , y ) out1\_G ( x , y ) = gain 1 ( x , y ) \times G ( x , y ) out1\_B ( x , y ) = gain 1 ( x , y ) \times B ( x , y ) \qquad ( 16 )$$

In a case where the first tone mapping processing is haze correction, the first gain processing unit 205 applies the first gain maps for each of R, G, and B in accordance with the following formula (17), which is based on the haze model. In formula (17), gain1_{R} (x, y), gain1_{G} (x, y), and gain1_{B} (x, y) indicate the first gain maps that respectively correspond to R, G, and B.

$$[ Math . 17 ]$$

$$out 1 \_R ( x , y ) = gain {1}_{R} ( x , y ) \times ( R ( x , y ) - {A}_{R} ) + {A}_{R} out 1 \_G ( x , y ) = gain {1}_{G} ( x , y ) \times ( G ( x , y ) - {A}_{G} ) + {A}_{G} out 1\_B ( x , y ) = gain {1}_{B} ( x , y ) \times ( B ( x , y ) - {A}_{B} ) + {A}_{B} \qquad ( 17 )$$

In step S808, the second gain processing unit 208 applies gain processing (the second tone mapping processing) for applying the second gain map generated in step S806 to the target image to which the first tone mapping processing has already been applied in step S807. Although the details of processing of step S808 are similar to step S807, the following formula (18) or formula (19) is used in place of formula (16) or formula (17). In formula (18) and formula (19), out1_R (x, y), out1_G (x, y), and out1_B (x, y) indicate the target image to which the first gain map has already been applied in step S807, and out2_pix (x, y) indicates the target image to which the first gain map and the second gain map have already been applied. Also, gain2 (x, y) indicates the second gain map, and gain2_{R} (x, y), gain2_{G} (x, y), and gain2_{B} (x, y) indicate the second gain maps that respectively correspond to R, G, and B. The second gain processing unit 208 executes gain processing (the second tone mapping processing) for applying the second gain map to the target image to which the first gain map has already been applied in accordance with formula (18) (in a case where the second tone mapping processing is highlight/shadow correction or clarity correction) or formula (19) (in a case where the second tone mapping processing is haze correction).

$$[ Math . 18 ]$$

$$out2\_R ( x , y ) = gain 2 ( x , y ) \times out 1 \_R ( x , y ) \\ out2\_G ( x , y ) = gain 2 ( x , y ) \times out1\_G ( x , y ) out2\_B ( x , y ) = gain 2 ( x , y ) \times out1\_B ( x , y ) \qquad ( 18 )$$

$$[ Math . 19 ]$$

$$out2\_R ( x , y ) = gain {2}_{R} ( x , y ) \times ( out1\_R ( x , y ) - {A}_{R} ) + {A}_{R} out2\_G ( x , y ) = gain {2}_{G} ( x , y ) \times ( out1\_G ( x , y ) - {A}_{G} ) + {A}_{G} out2\_B ( x , y ) = gain {2}_{B} ( x , y ) \times ( out1\_B ( x , y ) - {A}_{B} ) + {A}_{B} \qquad ( 19 )$$

In step S809, the image output unit 209 outputs the image to which the second tone mapping processing has already been applied in step S808 as an output image.

### Summary of Second Embodiment

As described above, according to the second embodiment, even when the target image is a color image, the image processing unit 102 can execute at least parts of processing necessary for the first tone mapping processing and processing necessary for the second tone mapping processing in parallel, similarly to the first embodiment. Therefore, according to the second embodiment, a time period required to apply a plurality of types of tone mapping processing to a color image can be reduced.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-218434, filed Dec. 25, 2023, which is hereby incorporated by reference herein in its entirety.

What is claimed is:

1. An image processing apparatus, comprising:
at least one memory configured to store instructions; and
at least one processor in communication with the at least one memory and configured to execute the instructions to:
generate, based on an image, a first evaluation image for first tone mapping processing;
generate, based on the image, a second evaluation image for second tone mapping processing, the second tone mapping processing being different from the first tone mapping processing;
generate, based on the first evaluation image, a first gain map for the first tone mapping processing;
apply the first tone mapping processing that is based on the first gain map to the second evaluation image;
generate, based on the second evaluation image to which the first tone mapping processing has already been applied, a second gain map for the second tone mapping processing;
apply the first tone mapping processing that is based on the first gain map to the image; and
apply the second tone mapping processing that is based on the second gain map to the image to which the first tone mapping processing has already been applied.

2. The image processing apparatus according to claim 1, wherein
each of the first tone mapping processing and the second tone mapping processing is one of brightness correction, contrast correction, and haze correction.

3. The image processing apparatus according to claim 2, wherein
the first tone mapping processing is the haze correction, and
to generate the first gain map, the at least one processor executes the instructions to generate a transmission map based on the first evaluation image.

4. The image processing apparatus according to claim 2, wherein
the second tone mapping processing is the haze correction, and
to generate the second gain map, the at least one processor executes the instructions to generate a transmission map based on the second evaluation image.

5. The image processing apparatus according to claim 1, wherein
the at least one processor executes the instructions to generate the first evaluation image based on the image and on a low-frequency image generated from the image.

6. The image processing apparatus according to claim 1, wherein
the at least one processor executes the instructions to generate the second evaluation image based on the image and on a low-frequency image generated from the image.

7. The image processing apparatus according to claim 1, wherein
the image is a monochrome image.

8. The image processing apparatus according to claim 1, wherein
the image is a color image.

9. An image capturing apparatus, comprising:
the image processing apparatus according to claim 1; and
an image capturing sensor configured to generate the image.

10. An image processing method executed by an image processing apparatus, comprising:
generating, based on an image, a first evaluation image for first tone mapping processing;
generating, based on the image, a second evaluation image for second tone mapping processing, the second tone mapping processing being different from the first tone mapping processing;
generating, based on the first evaluation image, a first gain map for the first tone mapping processing;
applying the first tone mapping processing that is based on the first gain map to the second evaluation image;
generating, based on the second evaluation image to which the first tone mapping processing has already been applied, a second gain map for the second tone mapping processing;
applying the first tone mapping processing that is based on the first gain map to the image; and
applying the second tone mapping processing that is based on the second gain map to the image to which the first tone mapping processing has already been applied.

11. A non-transitory computer-readable storage medium which stores a program for causing a computer to execute an image processing method comprising:
generating, based on an image, a first evaluation image for first tone mapping processing;
generating, based on the image, a second evaluation image for second tone mapping processing, the second tone mapping processing being different from the first tone mapping processing;
generating, based on the first evaluation image, a first gain map for the first tone mapping processing;
applying the first tone mapping processing that is based on the first gain map to the second evaluation image;
generating, based on the second evaluation image to which the first tone mapping processing has already been applied, a second gain map for the second tone mapping processing;
applying the first tone mapping processing that is based on the first gain map to the image; and
applying the second tone mapping processing that is based on the second gain map to the image to which the first tone mapping processing has already been applied.
